(19) United States
(12) Patent Application Publication
(10) Pub. No.: US 2007/0158032 A1
(43) Pub. Date: Jul. 12, 2007

(54) Device for covering profile material

(75) Inventor: Uwe Wagner, Gutersloh (DE)

Correspondence Address: BROWDY AND NEIMARK, P.L.L.C.;624 NINTH STREET, NW, SUITE 300, WASHINGTON, DC, 20001-5303, US

(73) Assignee: Delle Vedove Machinenbau GMBH, Schloss Holte-Stukenbrock (DE)

(21) Appl. No.: 10/589,020

(22) PCT Filed: Feb. 7, 2005
(86) PCT No.: PCT/EP05/01203

§ 371 Date: Aug. 10, 2006

(30) Foreign Application Priority Data
Feb. 11, 2004 (DE) 10 2004 006 569.1

(51) Int. Cl. B32B 37/00

(52) U.S. Cl. 156/582

(57) ABSTRACT

The invention relates to a device for covering profile material, comprising a roller conveyor (FR), whereon the profile material (P) is longitudinally guided, and pressure rollers (W1-W6) which can be positioned, respectfully, in relation to each other in a pressure position, such that a proportioned covering material (F) is pressed about the profile of the profile material (P) which is oriented transversal to or slightly on the conveying device, wherein single or several pressure rollers (W1-W6) are arranged successively in groups in the direction of conveyance and are pressed, respectively, by means of a multi-axis positioning device (RA1, RA2). The positioning device (RA1, RA) supports an automatically actuatable coupling (K, K1), whereon the pressure roller (W1-W6) is maintained in a defined, oriented manner, and magazine compartments (M1, M6), which are not necessary, are placed in a couplable manner.

The invention relates to a device for covering profile material, comprising a roller conveyor, whereon the profile material is longitudinally guided, and pressure rollers which can be positioned, respectively, in relation to each other in a pressure position, such that a proportioned covering material is pressed about the profile of the profile material which is oriented transversal to or slightly on the conveying device, wherein single or several pressure rollers are arranged successively in groups in the direction of conveyance and are pressed, respectively, by means of a multi-axis positioning device, which supports an automatically actuatable coupling.

The document EP 0997260 A2 describes such a device. The installation consists of several frames, each of which comprises in one group two pressure rollers, respectively equipped with one x-y positioning device and one swivelling and tracking transmission unit, the latter being driven by two motors. Both linear transmissions are equipped with step motors and set to a standardized normal position, to which they can be reset in a reproducible manner. All positioning devices of all groups have one central control and can be programmed to adjust to a given profile, so that an even covering is assured as long as the different profiles are similar and the same pressure rollers are used. This does not fulfill the conditions of modern logistics of delivery and production, since a great number of profiles and covering materials come into use, hence the extensive storage, permitting a reduction of retooling processes, would be much too costly. As a result, the production of smaller charge quantities of a specific covered profile proves to be very uneconomic, due to the set-up time necessary for manually exchanging the individually fit pressure rollers and readjusting their normal position, this process often taking several hours overall.

The patent DE 19508864 describes a device for covering profile material with a roller conveyor, according to the state of the art.

The utility model DE 29910871 U1 brings forward a bordering mechanism with a positioning device, the latter supporting a coupling, whereon a pressure roller is maintained in a defined, oriented manner.

The utility model DE 29821047 U1 shows an arrangement of machine tools, with magazine compartments placed in the positioning area of the positioning device, wherein pressure rollers, which are not necessary, are placed in an oriented, couplable manner.

Generally, robots with a sensor-signal dependent motor control are known from the utility model DE 29800217.

It is the object of the invention to make manual retooling dispensable even for very dissimilar profiles, thereby reducing set-up time, and to simplify the known devices.

This object is met in such a way that the positioning device supports an automatically actuatable coupling, whereon the pressure roller is maintained in a defined, oriented manner, and magazine compartments are respectively arranged in a positioning area of the coupling, wherein pressure rollers, which are not necessary, are placed in a couplable manner.

Advantageous embodiments of the invention are presented in the subclaims.

The coupling between the roller and the positioning device is advantageously equipped with a centering means and an orientation means, so that the roller is coupled onto the positioning device in a defined position, which need not be readjusted after an exchange of rollers. Preferably, the coupling is actuated by a mechanical release, or automatically controlled by electromagnetic, pneumatic or hydraulic means.

Within the magazine, the roller is advantageously maintained in such a way, that a pressing force during coupling and a stripping force during uncoupling are taken up.

After coupling the roller can be taken out in a direction transversal to the direction of the centering axis of the coupling, possibly by releasing the unlatching mechanism or by actuating a latching mechanism or locking piece.

Since the anticipated covering device comprises the positioning devices in a frame, and the positioning devices move essentially within the plane of the frame, and normally many frames are positioned one behind the other at small intervals, practically no space is left to install a magazine, permitting to automatically take out rollers, within the reach of the positioning device.

Expediential positioning devices are commercially available robots with five or six rotational axes, the free ends of their arms maintaining a coupling or an equivalent gripper. This way, it is possible to position each magazine in an area out of the way of the roller conveyor, which is well accessible, due to the degrees of freedom attained by the turning robot segments. For example the said magazine can be situated on a tier above the roller conveyor, or at the opposite side of the robot.

Functionally, the robots are fixed next to or on the roller conveyor, which assures a permanent and defined adjustment and position measuring towards the plane of the roller conveyor, and consequently towards the surface of the profile to be covered.

The robot arms possess a certain elasticity, and the rollers require a defined high pressing force necessary for a durable covering conforming to specifications. Therefore, after the roller reaches the correct position and orientation on the profile, the robot arm is charged and strained, perpendicularly to the contact line or plane, by the corresponding positioning motors, until the roller is pressed with a preset force. This force is either produced by the motor current, according to the constellation of the robot segments, and preferably detected by a current meter, or measured by a force sensor at the coupling. The current measuring signal, the force measuring signal, or both, advantageously contribute to a current-force regulation, thereby assuring that variations of the profile, the covering material and the roller diameter do not affect the pressing force. This is decisive for the quality of the glueing, particularly when applying a thin foil on hard material, such as metal. Another advantage of said power regulation, allowing a compensation of the strain and bearing clearance of the robot arm, is the resulting possibility to employ comparatively lightweight, inexpensive robots.

A permanent generation of force by supplying current to the servomotors would cause a permanent energy consumption, which can be avoided with a controllable blocking or self-locking of the robot's motor axes or transmission axes. Actuation is switched on for a short period, either periodically, or at a significant change of force signalled by the force sensor, possibly at a release of the blocking, in order to compensate possible tolerance variations. Variations of angle and position are registered and monitored, and changes that are recognized as unacceptable are reported to a master control. If, as usual, a self-locking transmission is subsequent to the motor, a blocking brake becomes obsolete.

All robots with their drive controls, measuring means and blocking controls are networked with a master controlling and monitoring processor. Said processor has input and output units, permitting the installation to adjust to a new profile and new materials, and contains a memory that supplies information about the magazine stock, the previously memorized profiles with corresponding tool inserts, as well as data about coordinates and force-current values with their extent of tolerance.

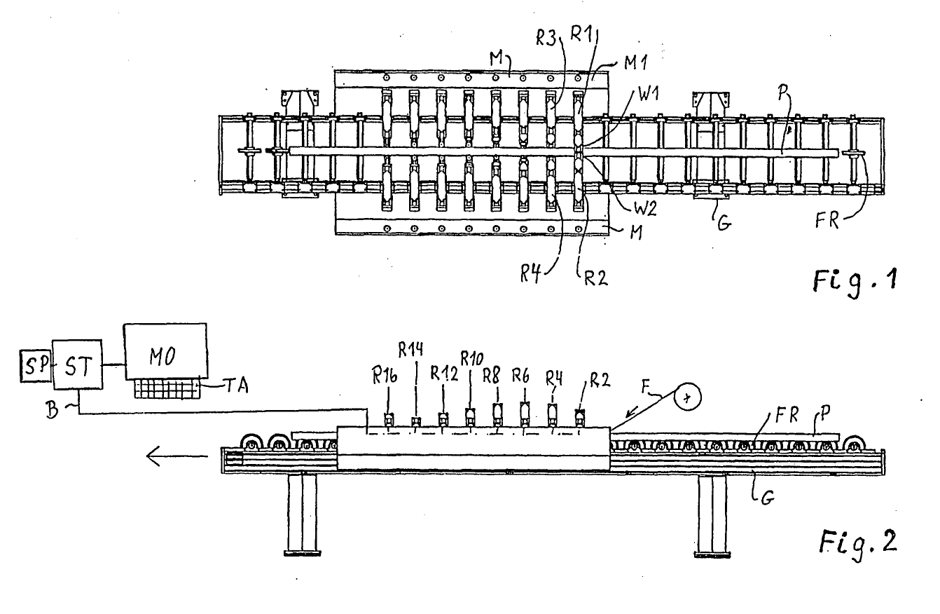

In the FIGS. 1 to 3 an advantageous embodiment of the invention is described in more detail.

FIG. 1 shows a top view of a production line for covering profile material

FIG. 2 shows a side view corresponding to FIG. 1

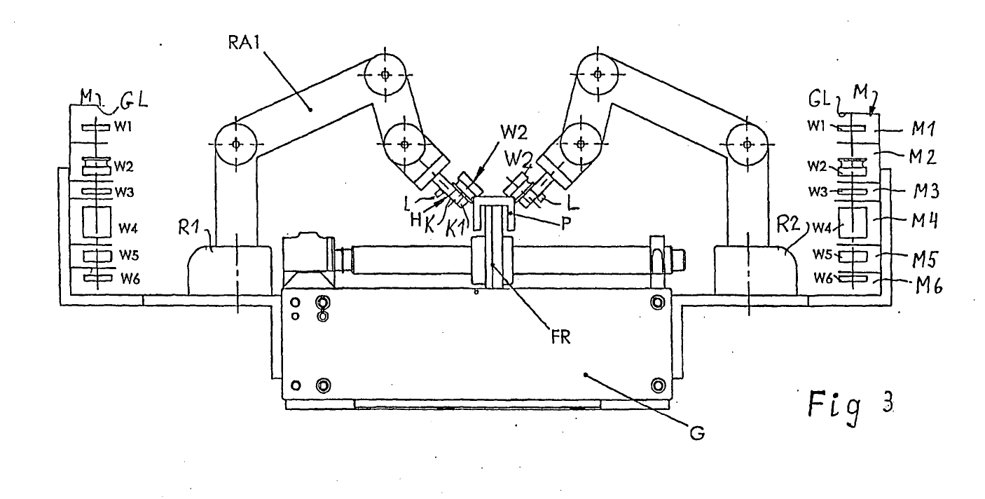

FIG. 3 shows a front view corresponding to FIG. 1

FIG. 1 and 2 show a conveyor stand G with a roller conveyor with rollers FR, which are powered, so the profile-material bars P are longitudinally guided. The covering material F, a veneer or a foil, with an adhesive underside, is placed on top of the profile by an uncoiler or take-down device (not shown), and rolled on by the pressure roller W1. The salient parts of the foil at the sides of the profile are flattened and pressed on, strip by strip, by succeeding rollers at succeeding stations, particularly by symmetrically arranged roller pairs, the axes of which are parallel to a profile section, as shown in FIG. 1. As shown in FIG. 3, the roller axes are oriented slightly on the conveying direction of the profile, in the known manner.

It is known that, depending on the type of profile used and on the orientation of the rollers, a variety of cylindrical, concave or crowned profile contours have proven adequate.

The Roller W2 is maintained on a through axis in a mounting H, the latter carrying a coupling K, which is attached to its complementary coupling K1 at the end of a robot arm RA1. The coupling K is fastened to its counterpart K1 by means of locking or latching mechanisms.

Additional rollers W1-W6 with different contours and/or dimensions are stored in magazine compartments M1-M6 of magazines M, their coupling K oriented in such a way, that the robot R1 can connect it to the complementary coupling K1 after disconnecting and depositing the previous roller W1. If the robot does not control directly, by way of a gripper, the complementary coupling K1, the coupling section K of the roller W1 is inserted, for example, into a fork GL of the corresponding magazine compartment M1, the fork GL then actuating a release mechanism L. The release permits the robot R1 to withdraw the complementary coupling K1 from the coupling K, and to connect to another roller by reversing the process, and to take it out of the magazine.

The coupling K1 shows, towards the complementary coupling K1, centering means such as an inner and an outer cone or pyramid-shape, angular orientation means such as radial extensions and grooves, as well as axial limit stops or edges, which, combined, result in a definite positioning of the roller, when the coupling is latched or locked. The resilience of the locking is advantageously produced by a spring, the latter being connected to spreading levers, which cooperate with a spreader and an actuator on the magazine compartment to release the coupling K1.

The motors of the robot RA1 are equipped with brakes, which are actuated by an electromagnetic, pneumatic or hydraulic central control. However, the installation of self-locking transmissions subsequent to the motor is preferable.

FIG. 3 shows a pressure roller W2, respectively on both sides of the profile P and its conveyor. The rollers W2 touch only a small section of the profile, due to the rounding of its sides. Therefore, they are relatively short with a concave contour. The following pressure stations, showing a steeper orientation of the roller axes succeed the first station in the direction of the conveyor.

FIG. 1 and FIG. 2 schematically show a typical general outlay of a production line for covering profile material. Profiles and covering material are brought together. Possibly, a hot-air fan melts the clue coating of the covering material F, followed by stations with pressure rollers W1-W2, comprising one to three robots R1-R16 each. Magazines for exchange rollers are positioned at the sides.

All robots R1-R16 are linked, via cables and message lines B, to a master control ST, connected to which is operating equipment, such as the monitor MO and the keyboard TA, and a memory SP, the latter storing the control program and the adjustment data, as well as profile-related information.

1. Device for covering profile material, comprising a roller conveyor (FR), whereon the profile material (P) is longitudinally guided, and pressure rollers (W1-W6) which can be positioned, respectively, in relation to each other in a pressure position, such that a proportioned covering material (F) is pressed about the profile of the profile material (P) which is oriented transversal to or slightly on the conveying device, wherein single or several pressure rollers (W1-W6) are arranged successively in groups in the direction of conveyance and are pressed, respectively, by means of a multi-axis positioning device (RA1, RA2), characterized in that the positioning device (RA1, RA2), support an automatically actuatable coupling (K1, K2), whereon the pressure roller (W1-W6) is maintained in a defined, oriented manner, and magazine compartments (M1-M6) are respectively arranged in a positioning area of the coupling (K1), wherein pressure rollers (W2-W6), which are not necessary, are placed in a couplable manner.

2. Device according to claim 1, characterized in that the complementary couplings (K, K1) comprise centering means such as an inner and an outer cone or pyramid-shape, angular orientation means such as a radial extension and a groove or edges, as well as axial limit stops.

3. Device according to claim 1, characterized in that the coupling (K, K1) comprises radially actuatable locking pieces or latching mechanisms.

4. Device according to claim 3, characterized in that the individual magazine compartments (M1-M6), respectively, support roller seats, which maintain coupling release devices (GL) cooperating with the locking pieces (L).

5. Device according to claim 4, characterized in that the coupling release device is a divergent open fork, which encompasses the coupling (K1) tightly and, in the course of which, operates a button (L) or a lever to release the coupling.

6. Device according to claim 5, characterized in that the centering devices are perpendicular to an axis of a pressure roller, and that the fork (GL) is oriented radially to the couplings (K, K1).

7. Device according to claim 1, characterized in that the positioning devices (RA1, RA2) are robots (R1-R16) turning in five or six degrees of freedom.

8. Device according to claim 7, characterized in that the robots (R1-R16) are fixed next to or on the roller conveyor (FR).

9. Device according to claim 7, characterized in that the robots (R1-R16) can be positioned by means of servomotors and angle transmitters, and possess a driving-force regulation, the actual signal of which is produced respectively by a motor-current signal and/or a force-sensor signal.

10. Device according to claim 9, characterized in that the force sensor is placed axially within the respective coupling (K).

11. Device according to claim 9, characterized in that the robots (R1-R16) are connected to a master controller (ST) via a message bus (B), the master controller being linked to controlling and operating means (MO, TA), and comprising a memory (SP), which contains profile-related positioning data and magazine-related pressure roller data.

12. Device according to claim 7, characterized in that the robots (R1-R16) comprise motors and/or transmissions, which can be arrested by controllable brakes or are self-locking, so that when idle, they keep their position.
